(19) United States
(12) Patent Application Publication
(10) Pub. No.: US 2025/0248870 A1
(43) Pub. Date: Aug. 7, 2025

(54) LIFTING DEVICE HAVING A RETRACTABLE FOOT PEDAL TO LIFT PATIENTS TO STANDING POSITION

(71) Applicant: RESTORATIVE CARE OF AMERICA, INC., St. Petersburg, FL (US)

(72) Inventor: Augustus B. TURNBULL, St. Petersburg, FL (US)

(21) Appl. No.: 19/047,424

(22) Filed: Feb. 6, 2025

Related U.S. Application Data
(60) Provisional application No. 63/550,213, filed on Feb. 6, 2024.

(51) Int. Cl. A61G 5/14; A61G 5/10; A61G 5/12

(52) U.S. Cl. CPC A61G 5/14; A61G 5/1059; A61G 5/128

(57) ABSTRACT

An apparatus comprises a base frame comprising a rear end, at least one rod mechanically coupled to the rear end, a lift tube mechanically coupled to the at least one rod, and a pedal tube mechanically coupled to the lift tube. The apparatus further comprises a foot pedal mechanically coupled to the pedal tube. In an open position, the foot pedal is extendable upward and outward from the pedal tube such that the foot pedal is positioned in front of the base frame. A downward force applied to the foot pedal causes an opposite end of the pedal tube and the lift tube to lift via the first cross-support arm, to raise the rear end of the base frame via the at least one rod. In a closed position, the foot pedal is retracted into the pedal tube such that the foot pedal can be stowed under the base frame.

### CROSS-REFERENCE TO RELATED APPLICATION(S)

This application is non-provisional application and claims the benefit of priority under 35 U.S.C. § 119(e) of U.S. Provisional Patent Application Ser. No. 63/550,213 filed Feb. 6, 2024, and entitled “TOTAL-UP CARE CHAIR,” the disclosure of which is incorporated herein by reference in its entirety.

### FIELD

The present disclosure generally relates to the field of lifting device. In particular, the present disclosure is related to an apparatus for a lifting device having a retractable foot pedal to lift patients to a standing position. In a another embodiment the present disclosure is related to an apparatus for a lifting device having a retractable and foldable foot pedal to lift patients to a standing position.

### BACKGROUND

As people age, the degeneration of body functions often results in reduced knee strength, weaker hips and legs, and increased fatigue, making it difficult for seniors to sit down or stand up without assistance. Additionally, clinicians in an institutional setting are often tasked with lifting or otherwise assisting patients from a seated to standing position. Such a task can create injury to both the patient as well as the clinician.

Some conventional seating devices are generally not designed to accommodate these challenges, leaving elderly or disabled individuals dependent on others for basic movements. Conventional wheelchairs provide essential mobility and safety for disabled or elderly individuals, traditional designs with fixed leg rests and backrests lack adaptability, forcing users to remain in the same seated position for prolonged periods. Some improvements to wheelchairs incorporate adjustable backrests and adaptable features to enhance comfort, independence, and overall usability with an additional component such as a foot lever such that a wheelchair user can lift himself up independently or with the help of a clinician. However, this new component can often be a hindrance for users due its location and protrusion. A need for a wheelchair design that can lift users from the seated position without hindering their movement, positioning, or comfort exists.

### SUMMARY OF THE INVENTION

In one or more embodiments, an apparatus comprises a base frame comprising a rear end, at least one actuating rod mechanically coupled to the rear end, a lift tube mechanically coupled to the at least one rod, and a pedal tube mechanically coupled to the lift tube. The apparatus further comprises a foot pedal mechanically coupled to the pedal tube. In an open position, the foot pedal can be extended upward and outward from the pedal tube such that the foot pedal is positioned in front of the base frame. A downward force applied to the foot pedal causes an opposite end of the pedal tube and an opposite end of the lift tube to lift via the first cross-support arm, to raise the rear end of the base frame via the at least one actuating rod. In a closed position, the foot pedal is retracted into the pedal tube and folded such that the foot pedal can be stowed under the base frame.

In one or more embodiments, an apparatus comprises a base frame comprising a rear end and a back frame mechanically coupled to the base frame via a first pivot point. The back frame comprises a first cross-arm support. The apparatus further comprises a support frame mechanically coupled to the back frame via a second pivot point. The support frame comprises a second cross-support arm. The apparatus further comprises at least one hydraulic piston mechanically coupled to the second cross-support arm and the rear end, at least one actuating rod mechanically coupled to the rear end, and a lift tube mechanically coupled to the at least one rod and rotatably coupled to the first-cross support arm. The apparatus further comprises a pedal tube mechanically coupled to the lift tube and rotatably coupled to the first cross-support arm, and a foot pedal mechanically coupled to the pedal tube. In an open position, the foot pedal can be extended upward and outward from the pedal tube such that the foot pedal is positioned in front of the base frame. A downward force applied to the foot pedal causes an opposite end of the pedal tube and an opposite end of the lift tube to lift via the first cross-support arm, to raise the rear end of the base frame via the at least one actuating rod. In a closed position, the foot pedal can be retracted into the pedal tube, with an end that is also foldable on an axis, such that the foot pedal can be stowed under the base frame.

In one or more embodiments, a method comprises extending a foot pedal outward and upward from a pedal tube of a lifting device, such that the foot pedal is positioned in front of a base frame of the lifting device. The method further comprises applying a downward force to the foot pedal to cause the opposite end of the pedal tube loop and the opposite end of the lift tube to lift via the first cross-support arm, to raise the rear end of the base frame via the at least one actuating rod. The method further comprises releasing the foot pedal to raise the foot pedal and cause the rear end of the base frame to descend. The method further comprises applying an inward force to the foot pedal such that the foot pedal retracts into the pedal tube and the foot pedal can be stowed under the base frame.

### BRIEF DESCRIPTION OF THE DRAWINGS

FIGS. 1A-1C are schematic illustrations of an adjustable lifting device, according to some embodiments.

FIGS. 2A-2C are schematic illustrations depicting a retractable foot pedal for lifting a seat of the adjustable lifting device of FIGS. 1A-1C, according to some embodiments.

FIGS. 3A-3C are illustrative representations of an embodiment of the adjustable lifting device of FIGS. 1A-1C depicting a retractable telescoping foot pedal, according to some embodiments.

FIGS. 4A-4B are schematic illustrations depicting the adjustable lifting device of FIGS. 1A-1C in a folded and unfolded state, according to some embodiments.

FIGS. 5A-5B are illustrative representations of an embodiment of the adjustable lifting device of FIGS. 1A-1C in a folded and unfolded state and having a telescopic foot pedal, according to some embodiments.

FIG. 6 is a schematic illustration of a group of adjustable lifting devices stacked in a nesting formation, according to some embodiments.

FIG. 7 is an example flow diagram of a method for engaging the retractable foot pedal of the adjustable lifting device of FIGS. 1A-1C, according to some embodiments.

### DETAILED DESCRIPTION

In some embodiments, an apparatus for a lifting device is discussed herein. The lifting device can lift a patient from a sitting position to a standing position. The lifting device can enable a clinician to easily and efficiently control the ascent of an immobile patient who is getting up from a seated position or the descent of one who is going from a standing to seated position. The lifting device can include a mechanism or component that the clinician can engage with to cause the ascent of the patient. The mechanism or component can be physically located such that the clinician is not in a physically comprising position for the clinician when trying to lift or catch the patient if the event that the patient falls from the chair. The lifting device can also be foldable in a way that it can be conveniently stored or stacked with other lifting devices.

In some implementations, the lifting device described herein can include a foot pedal that protrudes from a pedal tube located below a seat of the lifting device. The foot pedal, in an extended state, can be pressed downwards by a clinician (or by a wheelchair user independently), to raise the rear end of the seat upwards and forwards, thereby lifting a patient sitting on the seat from a seated position to a pseudo-standing position, making it so the patient is in the optimal position to stand up with relative ease. In the event that the patient is unable to maintain a standing position following the assistance of the lifting device and falls backwards onto the lifting device, the seat can catch the patient and one or more hydraulic piston mechanisms mechanically coupled under the seat can cause the seat to slowly descend back to a seated position for the patient. The hydraulic piston(s) can gently control the descent, eliminating the need for the patient to grab onto a clinician if the patient falls backward. This can save the clinician from suddenly bearing the weight of a patient who is falling, keeping the clinician out of a scenario that could end up causing an injury.

In some implementations, the foot pedal of the lifting device can be retracted inward towards the pedal tube or tucked back in so that it is not protruding outwards of the seat, which may impede the movement of the seated patient or hinder the assistance of the clinician. For instance, when not in use, the foot pedal can be retracted inward and bended upwards via a point that couples the pedal tube to another tube (e.g., lift tube).

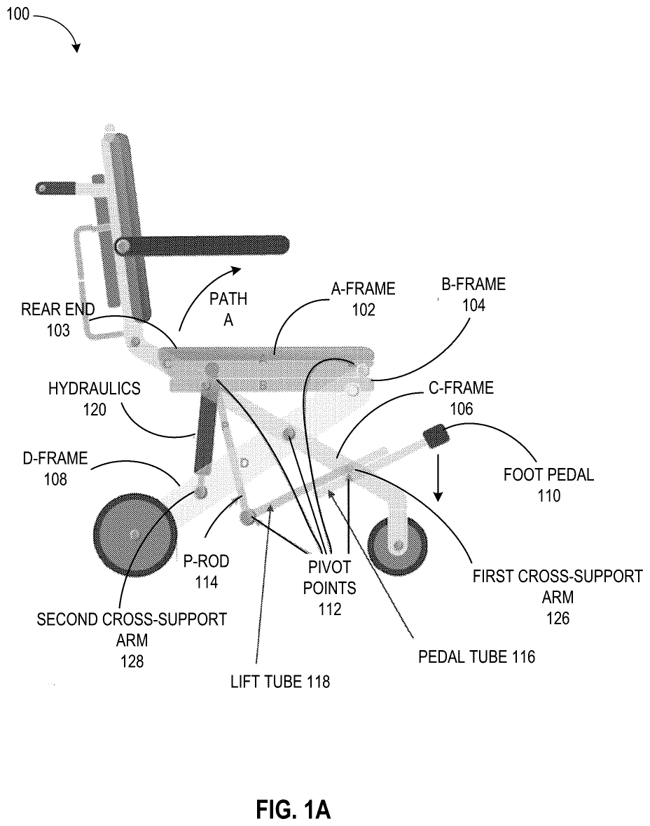

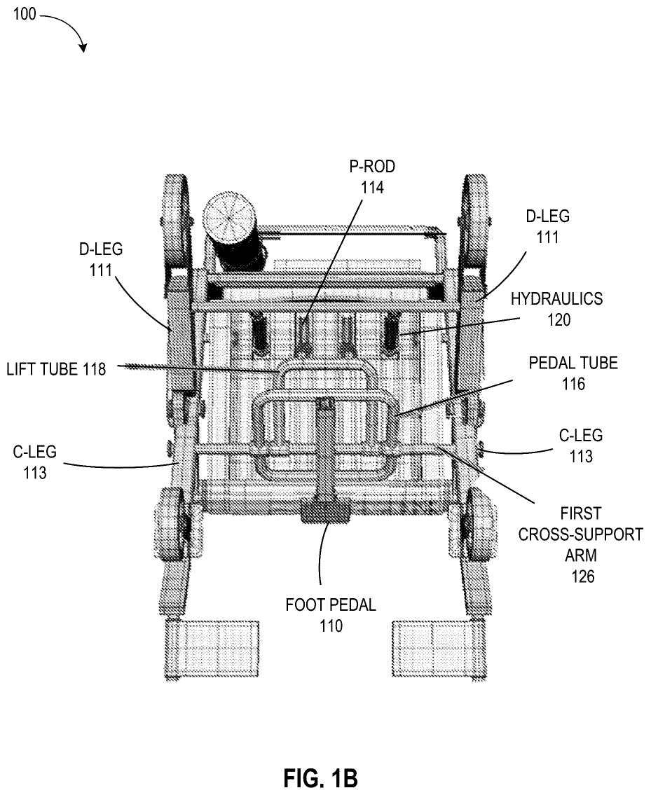

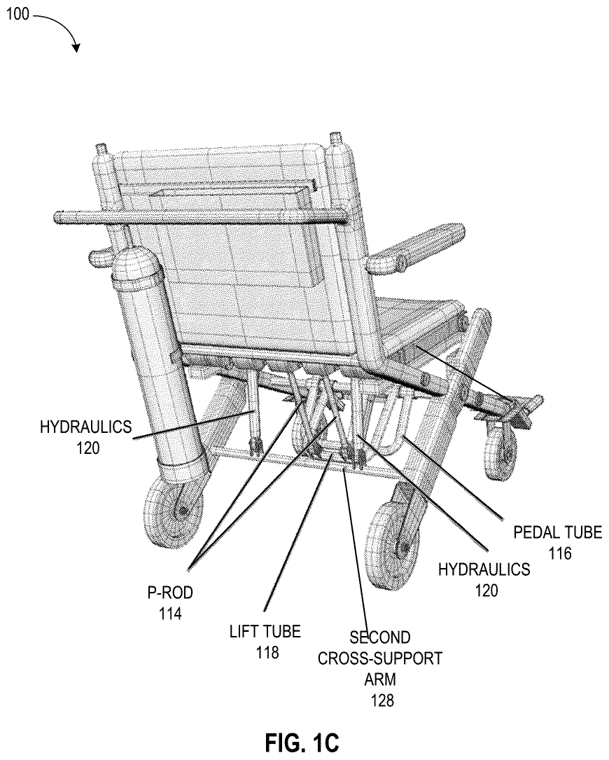

FIGS. 1A-1C are schematic illustrations of an adjustable lifting device 100, according to some embodiments. The lifting device 100 can include a base frame (also referred to herein as “A-frame 102”), a back frame (also referred to herein as “C-frame 106”), and a support frame (also referred to herein as “D-frame 108”). In some implementations, the A-frame 102 can be supported by a platform (e.g., B-frame 104) positioned parallel and below the A-frame 102. As shown in FIGS. 1A-1C, the lifting device 100 an be or include a chair or wheelchair and include a back rest (part of the C-frame 106) and arm rests for the comfort of a patient. The lifting device 100 can also include footrest (not shown in FIGS. 1A-1C) for the patient to rest their feet on.

In some implementations, the A-frame 102 can include a rear end 103]. The C-frame 106 can be mechanically coupled to the A-frame 102 via a first pivot point from multiple pivot points 112. The C-frame 106 can include two parallel legs (e.g., C-legs 113)] that are connected and supported by a first cross-support art 126. The D-frame 108 can be mechanically coupled to the C-frame 106 via a second pivot point from the multiple pivot points 112. The D-frame 108 can include two parallel legs (e.g., D-legs 111) that are connected and supported by a second cross support arm 128. The second pivot point 112 can also be a cross-support arm to connect the legs (e.g., D-legs 111) of the D-frame 108 and the legs (C-legs 113) of the C-frame 106 together, similar to a scissor mechanism.

In some implementations, the lifting device 100 can include at least one hydraulic piston 120 mechanically coupled to the second cross-support arm 128. The hydraulic piston 120 can also be mechanically coupled to the rear end 103 of the A-frame 102 (or B-frame 104). The hydraulic piston 120 can be configured to resist the descent of the A-frame 102 so that the A-frame 102 can slowly descend downwards.

In some implementations, the lifting device 100 can include at least one actuating rod (also referred to herein as “P-rod 114”) that is mechanically coupled to the rear end 103 of the A-frame 102. The lifting device 100 can also include a lift tube 118 that is mechanically coupled to the P-rod 114 and rotatably coupled to the first cross-support arm 126 of the C-frame 106. In some cases, the lift tube 118 can rotate along the longitudinal axis of the first cross-support arm 126, thereby lifting the P-rod 114 upwards and towards the rear end 103 of the A-frame 102 to raise the A-frame 102 along path A.

In some implementations, the lifting device 100 can include a pedal tube 116 that is mechanically coupled to the lift tube 118 and rotatably coupled to the first cross-support arm 126. The lifting device 100 can include a foot pedal 110 mechanically coupled to the pedal tube 116. The foot pedal 110 can be engaged such that it in an open position, the foot pedal 110 can be extended upward and outward from the pedal tube 116, enabling the foot pedal 110 to be positioned in front of and/or below the A-frame 102 (as shown in FIG. 1A). In some implementations, from the open position, the foot pedal 110 can be pressed downward by a clinician or a patient to cause an opposite end of the pedal tube 116 and an opposite end of the lift tube 118 to lift via the first cross-support arm 126, to raise the rear end of the A-frame 102 via the P-rod 114.

In some implementations, the lifting device 100 can include a lever system underneath the A-frame 102 that can be controlled by a clinician's foot. Applying downward pressure on the foot pedal 110 can drive the P-rod 114 upwards, pushing the A-frame 102 upward and forward, so that the seated patient is in an optimal position to stand up with relative ease. The lever mechanism of the foot pedal 110 allows clinicians to safely assist patients to a standing position by boosting the A-frame 102 upwards and forwards.

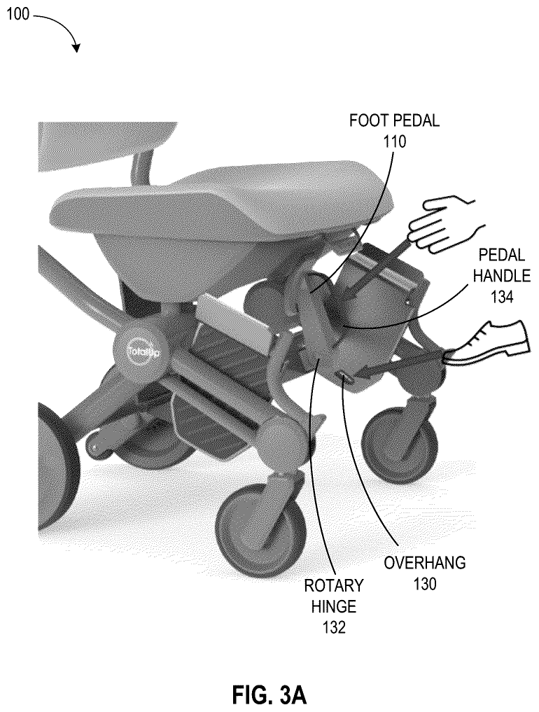

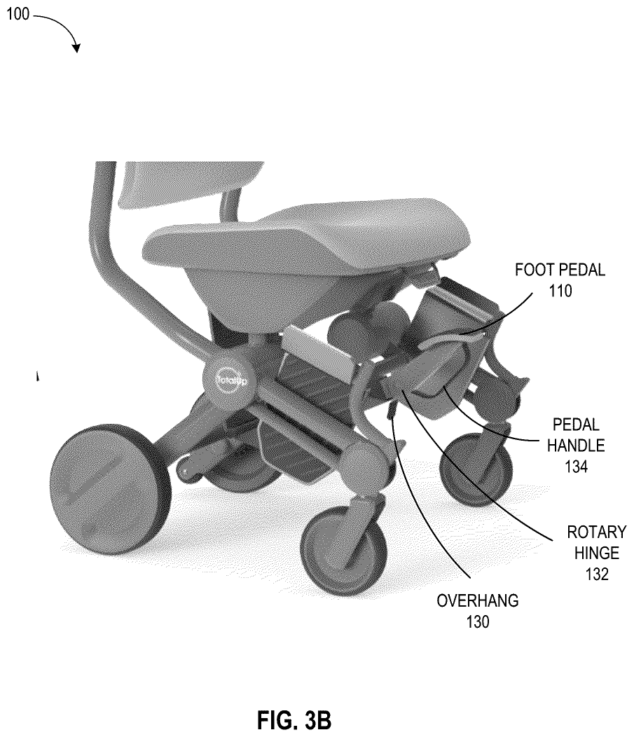

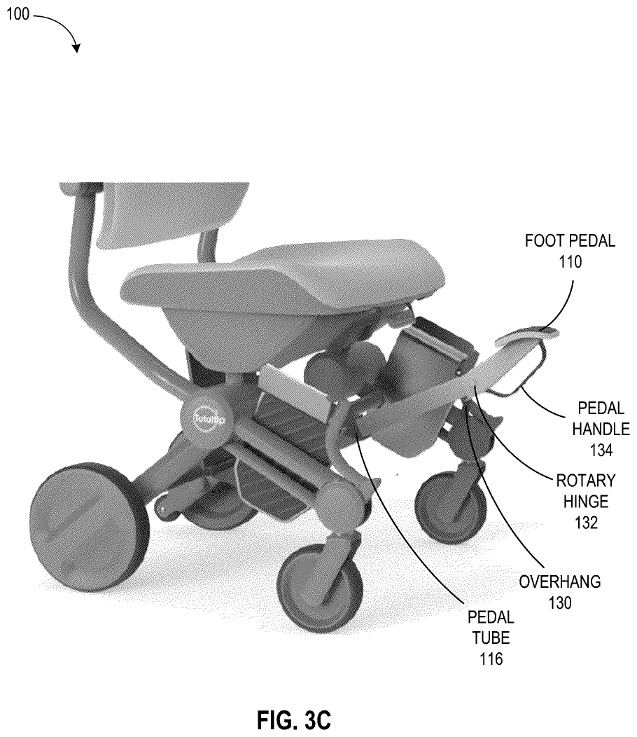

In some implementations, the foot pedal 110 can be retracted such that the foot pedal 116 is stowed below the A-frame 102. In some cases, the foot pedal 110 can be or include a telescopic foot pedal such that the foot pedal 110 can bend along a rotary hinge upwards and/or inwards to further hide or stow away the foot pedal 110, as best shown in FIGS. 3A-3C, discussed further below. This is so, at least in part, to remove the foot pedal 110 from hindering movement of a patient on the lifting device 100 as well as allowing for flexible movement to assist the patient by a clinician. The foot pedal 110 can telescope outward from underneath the A-frame 102 when it is ready for use and can be tucked back under the A-frame 102 and out of the way of the patient and clinician as shown in FIGS. 3A-3C.

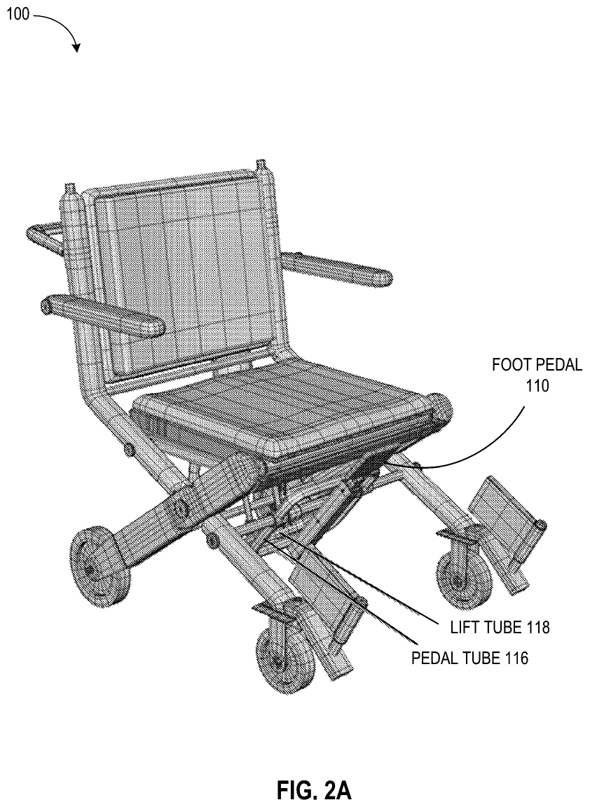

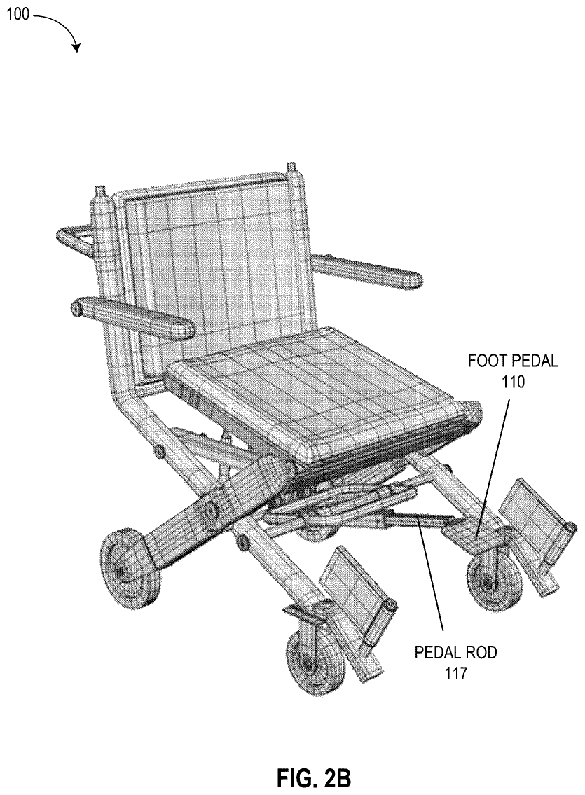

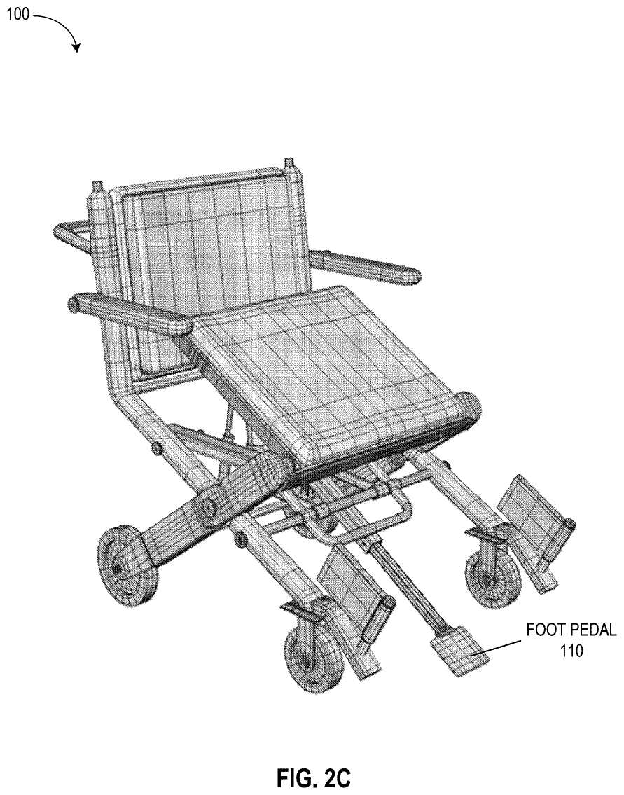

FIGS. 2A-2C are schematic illustrations depicting a retractable foot pedal for lifting a seat of the adjustable lifting device 100 of FIGS. 1A-1C, according to some embodiments. As shown in FIG. 2A, the lifting device 100 can be in a closed position where the foot pedal 110 is stowed under the seat (e.g., A-frame 102 of FIGS. 1A-1C). The foot pedal 110 and the pedal tube can be angled upwards.

As shown in FIG. 2B, the foot pedal 110 can be pulled or extended outward from the pedal tube, enabling a clinician or a patient to engage with it. As shown in FIG. 2C, the foot pedal 110 can be engaged and pressed downwards, causing the pedal tube and the lift tube to raise and press the P-rod upwards towards the rear end of the seat to allow for a seated patient to transition from a seated position to a pseudo-standing position. The foot pedal 110, the pedal tube, and the lift tube can be aligned or in parallel when the foot pedal 110 is engaged downwards. The first cross-support arm can be rotated from the pressure applied to the foot pedal 110 to cause the pedal tube and the lift tube to lift the seat upwards and forwards. The hydraulic pistons can further support the raised seat and slowly resist a descent of the seat when a patient falls backwards onto the seat and back in the seated position.

In a preferred embodiment the mechanical coupling of the foot pedal 110 to the pedal tube 116 can be achieved via a pedal rod 117 extending into the pedal tube 116 so that it can slide in and out of the pedal tube 116 to extend or retract the foot pedal 110. In a closed position, the foot pedal 110 can be retracted inward (by a clinician or a patient) towards the pedal tube 116, which includes a hollow channel inside to store a length of the pedal rod 117 of foot pedal 110.

In some implementations, a clinician can use their foot to lower the foot pedal 110 from a tucked in position. The foot pedal 110 can be locked in once extended. The foot pedal 110 can include a rounded, textured, non-slip surface to allow for ease of use as the foot pedal 110 can rotate, for example 61° in order to lift the seat up 36°.

FIGS. 3A-3C are illustrative representations of an embodiment of the adjustable lifting device 100 of FIGS. 1A-1C depicting a retractable telescoping and foldable foot pedal, according to some embodiments. A shown in FIG. 3A, the lifting device 100 can be at a closed position with the foot pedal 110 tucked in and folded up below the seat of the lifting device 100. The foot pedal 100 can be folded via a rotary hinge 132 that allows the foot pedal 110 to pivot upwards and inwards to be tucked under the seat. In some cases, the foot pedal 110 can include a pedal handle 134 that allows for a clinician to grab to pull the foot pedal 110 from the tucked in position downwards as it rotates around the rotary hinge 132 (as shown in FIG. 3B), and also assist is telescoping the foot pedal outward from the pedal tube. The foot pedal 110 can also include an overhang 130 at an opposite end that can also enable the foot pedal to be pivoted downward via the rotary hinge 132, via downward pressure by a clinician's foot. The foot pedal 110 can be pulled downwards such that it can be locked in position and parallel with the longitudinal axis of the pedal tube (not shown in FIG. 3B). As shown in FIG. 3C, in an open position, the foot pedal 110 is pulled outward, sliding out of the pedal tube 116, and locked in place using any suitable looking mechanism. Downward pressure on the foot pedal 110 can cause the seat to raise and lift a patient to a standing position.

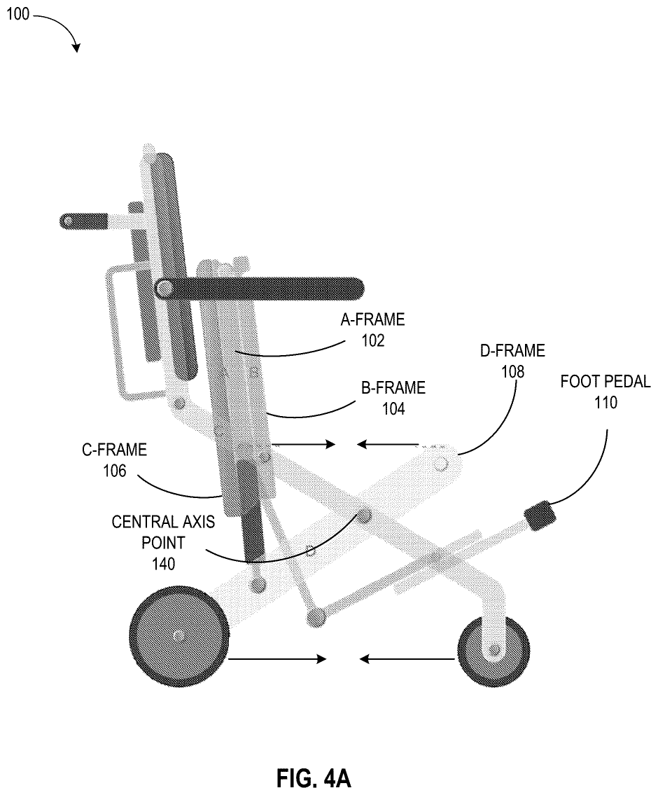

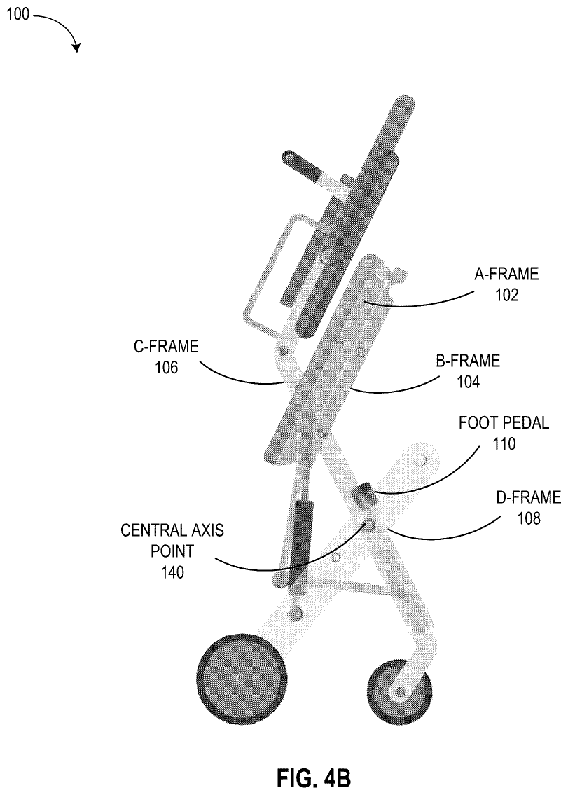

FIGS. 4A-4B are schematic illustrations depicting the adjustable lifting device 100 of FIGS. 1A-1C in a folded and unfolded state, according to some embodiments. In some implementations, the lifting device 100 can be folded such that the profile of the lifting device 100 can be narrow to make it easier to store when not in use. As shown in FIGS. 4A-4B, the lifting device 100 includes scissor frames (e.g., C-frame 106 and D-frame 108) that allows the lifting device 100 to convert between an in-use position and a stow or storage position. The B-frame 104 folds backward via a hinge located on the C-frame 106, carrying the A-frame 102 with it. In some cases, a front end of the B-frame 104 is not attached to the D-frame 108. Instead, the front end of B-frame 104 can rest in notches on inner sides of the D-frame 108, enabling the B-frame 104 to be fully supported when in use but also allow it to fold backward toward the seat back. The C-frame 106 and D-frame 108 can be connected via a hinge located at one of the pivot points 112, causing the C-frame 106 and the D-frame 108 to collapse toward each other via the central axis point 140 of the lifting device 100.

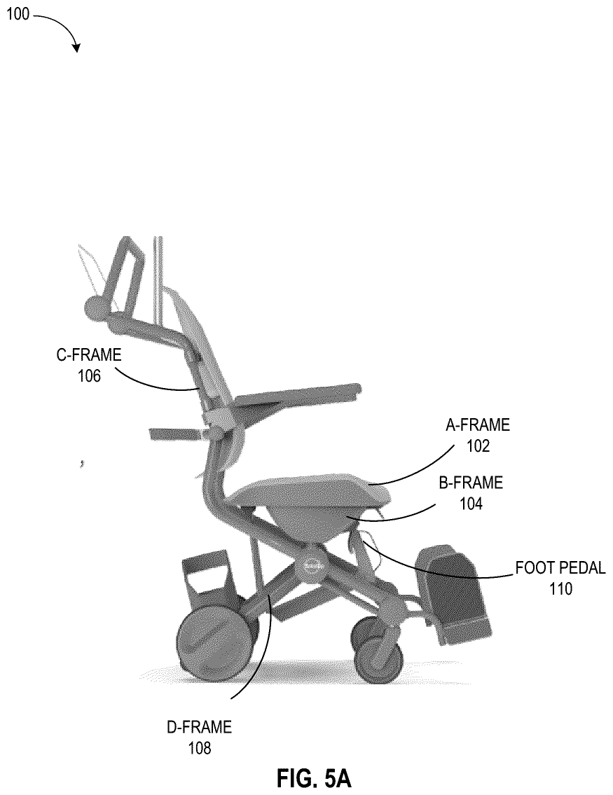

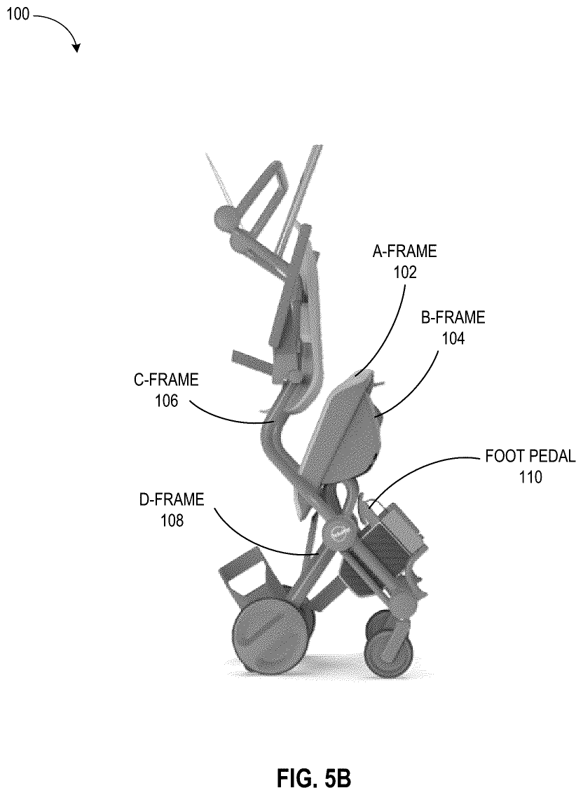

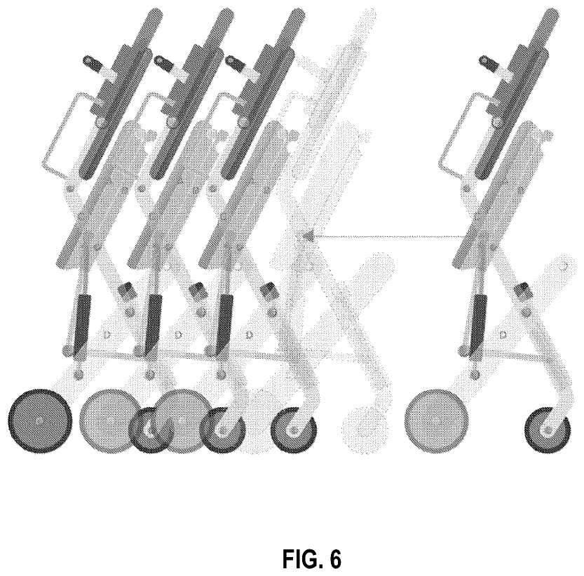

FIGS. 5A-4B are illustrative representations of an embodiment of the adjustable lifting device 100 of FIGS. 4A-4B in a folded and unfolded state and having a telescopic foot pedal, according to some embodiments. The foot pedal 110 can be telescopic and pivot upward and inward so that it is out of the way of a seated patient and a clinician. With the foot pedal 110 tucked in the upward position, the ability to nest several adjustable lifting devices for storage (see FIG. 6) is enhanced, since the foot pedal is out of the way and allows the nesting to be tighter. The foot pedal 110 can be retractable inward and/or outward from the pedal tube (not shown in FIGS. 5A-5B) so that the lifting device 100 can be folded more easily.

FIG. 6 is a schematic illustration of a group of adjustable lifting devices stacked in a nesting formation, according to some embodiments. One or more folded lifting devices of FIGS. 4A-4B can be nested or stacked against each other so that the one or more folded lifting devices can be stored more easily.

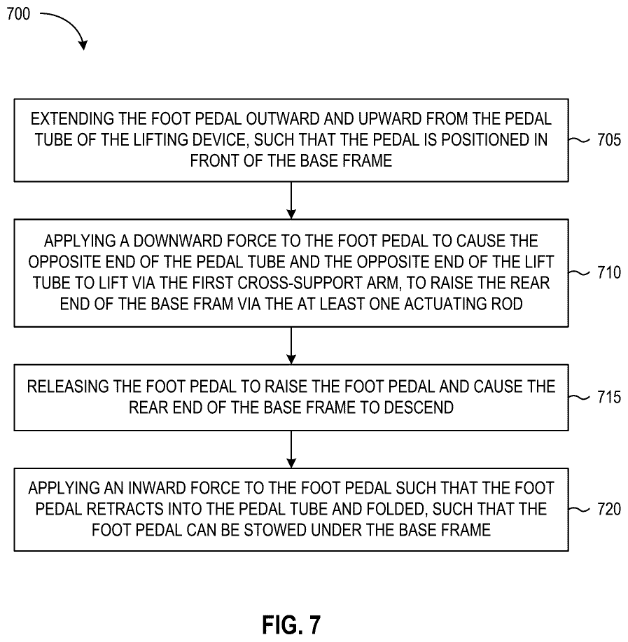

FIG. 7 is an example flow diagram of a method 700 for engaging the retractable foot pedal of the adjustable lifting device of FIGS. 1A-1C, according to some embodiments. At 705, the method 700 includes extending the foot pedal outward and upward from the pedal tube, such that the foot pedal is positioned in front of the base frame.

At 710, the method 700 includes applying a downward force to the foot pedal to cause the opposite end of the pedal tube and the opposite end of the lift tube to lift via the first cross-support arm, to raise the rear end of the base frame via the at least one rod.

At 715, the method 700 includes releasing the foot pedal to raise the foot pedal and cause the rear end of the base frame to descend.

At 720, the method 700 includes applying an inward force to the foot pedal such that the foot pedal retracts into the pedal tube and folded, such that the foot pedal can be stowed under the base frame.

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

The phrase “based on” does not mean “based only on,” unless expressly specified otherwise. In other words, the phrase “based on” describes both “based only on” and “based at least on.”

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An adjustable lifting device having:
a base frame comprising a rear end;
at least one actuating rod mechanically coupled to the rear end; and
a lift tube mechanically coupled to the at least one rod;
wherein the improvement comprises:
in an open position, a foot pedal that is extended upward and outward from a pedal tube such that the foot pedal is positioned in front of the base frame, such that a downward force applied to the foot pedal causes an opposite end of the pedal tube and an opposite end of the lift tube to lift via the first cross-support arm, to raise the rear end of the base frame via the at least one rod, and
in a closed position, the foot pedal is retracted into the pedal tube and folded such that the foot pedal can be stowed under the base frame.

2. The apparatus of claim 1, wherein the foot pedal is a telescoping foot pedal.

3. The apparatus of claim 1, wherein the rear end of the base frame can be raised and the foot pedal retracted within the pedal tube such that the adjustable chair is nestable with other adjustable chairs for easier storage.

4. An apparatus, comprising:
a base frame comprising a rear end;
a back frame mechanically coupled to the base frame via a first pivot point, the back frame comprising a first cross-arm support;
a support frame mechanically coupled to the back frame via a second pivot point, the support frame comprising a second cross-support arm;
at least one hydraulic piston mechanically coupled to the second cross-support arm and the rear end;
at least one actuating rod mechanically coupled to the rear end;
a lift tube mechanically coupled to the at least one rod and rotatably coupled to the first-cross support arm;
a pedal tube mechanically coupled to the lift tube and rotatably coupled to the first cross-support arm; and
a foot pedal mechanically coupled to the pedal tube,
wherein:
in an open position, the foot pedal is extended upward and outward from the pedal tube such that the foot pedal is positioned in front of the base frame,
a downward force applied to the foot pedal causes an opposite end of the pedal tube and an opposite end of the lift tube to lift via the first cross-support arm, to raise the rear end of the base frame via the at least one actuating rod, and
in a closed position, the foot pedal is retracted into the pedal tube and folded such that the foot pedal can be stowed under the base frame.

5. The apparatus of claim 4, wherein the rear end of the base frame can be raised and the foot pedal retracted within the pedal tube such that the adjustable chair is nestable with other adjustable chairs for easier storage.

6. The apparatus of claim 4, wherein the foot pedal is a telescoping foot pedal.

7. A method comprising:
extending the foot pedal outward and upward from the pedal tube of the apparatus of claim 1, such that the foot pedal is positioned in front of the base frame;
applying a downward force to the foot pedal to cause the opposite end of the pedal tube and the opposite end of the lift tube to lift via the first cross-support arm, to raise the rear end of the base frame via the at least one actuating rod;
releasing the foot pedal to raise the foot pedal and cause the rear end of the base frame to descend; and
applying an inward force to the foot pedal such that the foot pedal retracts into the pedal tube and folded, such that the foot pedal can be stowed under the base frame.
